(19) United States
(12) Patent Application Publication
(10) Pub. No.: US 2014/0059651 A1
(43) Pub. Date: Feb. 27, 2014

(54) Account Elevation Management

(71) Applicants: Ryan Lee Luster, Alabaster, AL (US); Mark R. Vevle, Birmingham, AL (US); Michael W. Peters, Liburn, GA (US)

(72) Inventors: Ryan Lee Luster, Alabaster, AL (US); Mark R. Vevle, Birmingham, AL (US); Michael W. Peters, Liburn, GA (US)

(73) Assignee: SOUTHERN COMPANY SERVICES, INC., Atlanta, GA (US)

(21) Appl. No.: 13/591,319

(22) Filed: Aug. 22, 2012

(51) Int. Cl. G06F 21/00

(52) U.S. Cl. 726/4

(57) ABSTRACT

Disclosed are various embodiments for elevating a user account by granting administrator permissions to workstations of network users. One embodiment of such a method comprises receiving authorization to provide a user temporary membership to an administrators group for a defined period of time; sending instructions to a workstation of the user to register as a member to the administrators group of the workstation; and in response to the membership having expired, sending instructions to remove the user as a member of the administrators group on the workstation.

### BACKGROUND

A large organization may have numerous users and workstations on a computer network. In order to prevent proliferation of viruses, worms, and malware on the computer network and to ensure that the computing network is in compliance with software and media licensing agreements, the organization may need to limit administrator permissions or rights that are available to workstation users on their workstations.

### BRIEF DESCRIPTION OF THE DRAWINGS

Many aspects of the present disclosure can be better understood with reference to the following drawings. The components in the drawings are not necessarily to scale, emphasis instead being placed upon clearly illustrating the principles of the disclosure. Moreover, in the drawings, like reference numerals designate corresponding parts throughout the several views.

FIG. 1 is a drawing of an account elevation environment according to various embodiments of the present disclosure.

FIG. 2 is a drawing of an event diagram depicting an embodiment of a process of requesting temporary administrator permission according to various embodiments of the present disclosure.

FIGS. 3-6 are drawings of exemplary user interfaces according to various embodiments of the present disclosure.

FIG. 7 is a drawing of an event diagram depicting an embodiment of a process of revoking administrators group membership privileges according to various embodiments of the present disclosure.

FIG. 8 is a drawing of an event diagram depicting an embodiment of processing expired membership privileges within an administrators group according to various embodiments of the present disclosure.

FIGS. 9-11 are diagrams of flowcharts illustrating various examples of functionality implemented as portions of the account elevation environment of FIG. 1 according to various embodiments of the present disclosure.

FIG. 12 is a schematic block diagram that provides one example illustration of a computing device employed in the account elevation environment of FIG. 1 according to various embodiments of the present disclosure.

### DETAILED DESCRIPTION

Techniques are described that facilitate elevation of a user account by granting of administrator permissions to workstations of network users in a manner that is manageable and auditable. Embodiments of the present disclosure accept an authorization of administrator permission on a workstation and assign the administrator permission for a specified period of time. Accordingly, the authorization may be for a temporary administrator permission for a short period of time or may be for a long-term administrator permission a longer period of time. Therefore, a user may be provided administrator permissions to install software or troubleshoot a particular workstation, as the user's duties require, which is tracked in an audit log, in some embodiments.

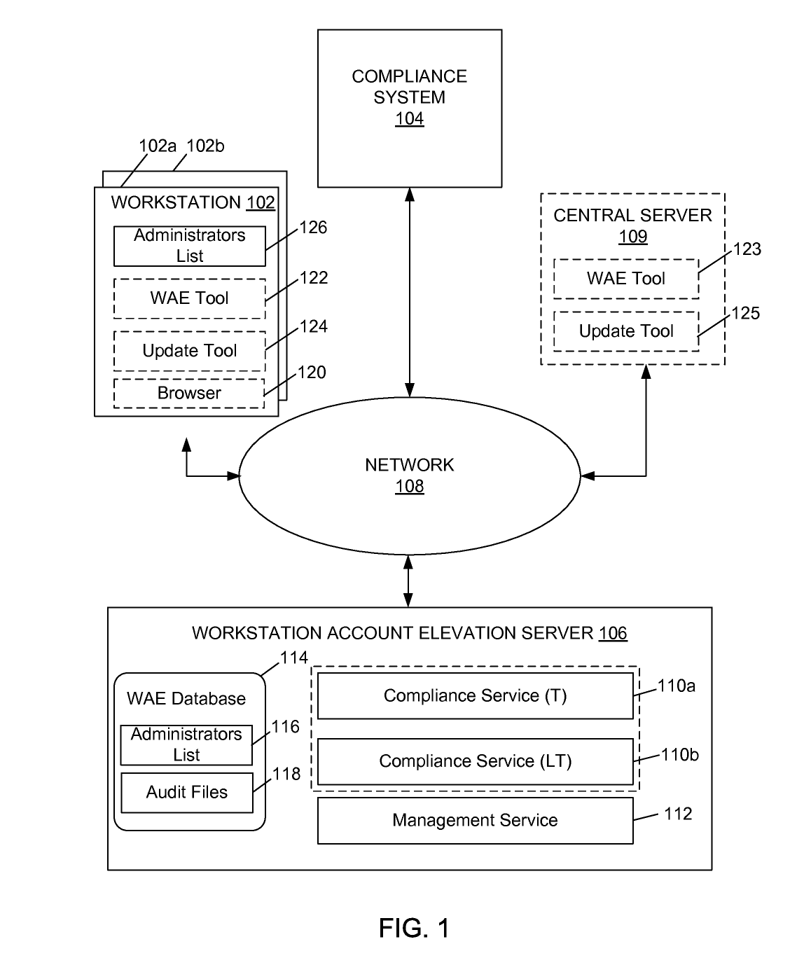

With reference to FIG. 1, shown are an account elevation environment 100 having one or more workstations 102, a compliance system 104, a workstation account elevation server 106, and a network 108. Consider that a large organization may have numerous users and workstations 102 on a computer network 108. While some users may have a dedicated workstation and only use that workstation, other users may use multiple workstations at least sometimes.

The network 108 includes, for example, the Internet, intranets, extranets, wide area networks (WANs), local area networks (LANs), wired networks, wireless networks, or other suitable networks, etc., or any combination of two or more such networks. The account elevation environment 100 may optionally include a central server 109 that interacts with the workstation(s) 102 and the workstation account elevation server 106, among other components.

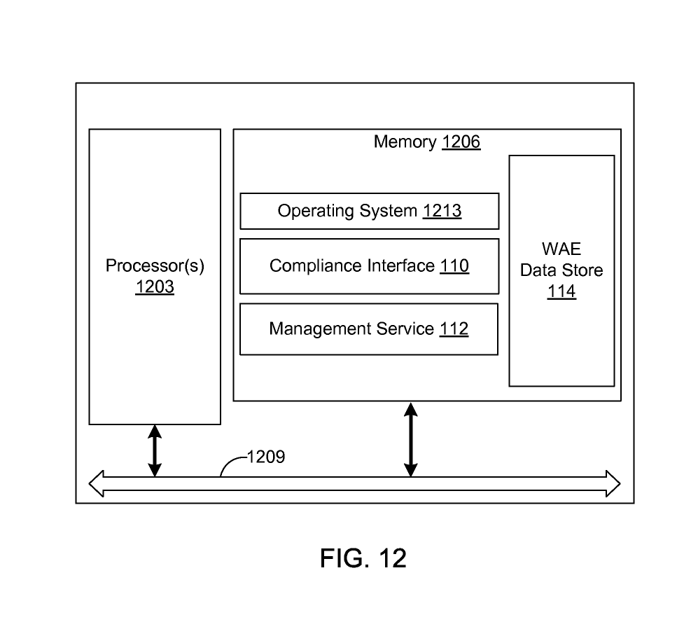

The workstation account elevation server 106 may further include computer systems or modules such as a compliance interface service 110 (temporary compliance interface service 110a or long-term compliance interface service 110b), a network management service 112, such as a web service, a workstation account elevation (WAE) store or database 114, etc. All of these services or systems may be effectuated by one or more computer systems similar to the computer device shown by FIG. 12.

The account elevation environment 100 may comprise, for example, a plurality of server computers or any other computing devices or systems providing computing capability. As such, the account elevation environment 100 may include multiple computer systems arranged, for example, in one or more server banks or other arrangements. Such computer systems may be located in a single installation or may be dispersed among many different geographical locations.

In one embodiment, the account elevation environment 100 can include computer systems configured to effectuate an authentication service, which can be used to authenticate a user that attempts to log into network-based resources to access information from its account or to access applications or data that is attached to or associated with the authenticated user or available on a workstation 102.

Various applications and/or other functionality may be executed by computer systems operating within the account elevation environment 100 according to various embodiments. Also, various data is stored in data store(s) 114 and is accessible to computer systems within the account elevation environment 100. The data store 114 may comprise a networked file share, a directory on a hard drive or other storage medium of a computing device 103, a relational database, a flat-file database, or any other mechanism for storing data. The data store 114 may be representative of a plurality of data stores as can be appreciated. The data stored in the data store(s), for example, is associated with the operation of the various applications and/or functional entities described below. Data store(s) may maintain, for example, user data, network accessible content, policies and permissions, and potentially other data.

The WAE data store 114 maintains, for example, records of administrator lists 116 for the various workstations 102 and potentially other data, such as profile data. Profile data may include a variety of information regarding the identity of the user, such as a user name, contact information, and/or other data relevant to the identity of the user. The contact information may include a mailing address, an email address, a telephone number, a fax number, or other contact information. Also, the WAE data store 114 may store log data or audit files identifying when a permission is requested, added, used, removed, and/or set to expire. In one embodiment, the audit files comprise a plurality of log files, where each of the files contains logon events associated with a corresponding user account. In one embodiment, the server 106 may have access to insert new logon events within the log data as the logon events are generated.

In an exemplary embodiment, each of the workstations 102 is coupled to the network 108. Also, each of the workstations or clients 102 may comprise, for example, a processor-based system such as a computer system. Such a computer system may be embodied in the form of a desktop computer, a laptop computer, a personal digital assistant, a cellular telephone, set-top box, music players, web pads, tablet computer systems, or other devices with like capability. To this end, each of the workstations 102 may comprise a mobile device as can be appreciated. Each of the workstations 102 may include, for example, various peripheral devices. In particular, the peripheral devices may include input devices such as, for example, a keyboard, keypad, touch pad, touch screen, microphone, scanner, mouse, joystick, or one or more push buttons, etc. The peripheral devices may also include display devices, indicator lights, speakers, etc. Specific display devices may be, for example, cathode ray tubes (CRTs), liquid crystal display (LCD) screens, gas plasma-based flat panel displays, LCD projectors, or other types of display devices, etc.

Executed within the workstations 102 are various applications including a client browser 120. The client browser 120 is configured to interact with a web service application program interface according to an appropriate protocol (e.g., TCP/IP). The client browser 120 may be executed in the workstation 102, for example, to access and render network accessible content, such as web pages, or other network content served up by the servers utilized within the account elevation environment 100. The workstation 102 may be configured to execute applications beyond the client browser 120, such as, for example, email applications, instant message applications, and/or other applications, including dedicated client-side applications. When executed in a workstation 102, the respective browser 120 renders a respective user interface on a respective display device and may perform other functions.

Users may not all have the same access rights within the network 108 of the account elevation environment 100. In order to prevent proliferation of viruses, worms, and malware on computer networks and to ensure that a computing environment is in compliance with software and media licensing agreements, corporations or organizations may employ the workstation account elevation server 106 to limit or regulate the amount of user administrative permissions or rights that are available to users on their workstations.

Accordingly, to request additional permissions, a user may generate a request for elevated access to one or more workstations via a compliance system 104. The request is received by the compliance system 104, where the compliance system 104 provides mechanisms to grant or deny the request. In some embodiments, the compliance system 104 may automatically decide whether to grant the request based on defined criteria or based on the type of request.

For example, a request for short-term or temporary administrator permission may be eligible to be decided by the compliance system 104 based on defined criteria, where a request for long-term administrator permission may need to be decided by a particular person or group. In order to implement authorization of a user's request, administrator permissions are granted by adding the user to an administrators group on a workstation that has the desired permission (e.g., a policy stating the underlying permission is associated with the group), in one embodiment. Possible actions performed by the workstation account elevation server 106 include fulfillment of the granting of the permission, monitoring the permission during its lifetime period, and removing the user from the administrators group after the period expires or after the permission is revoked, thereby removing associated administrative rights from the user for a workstation 102.

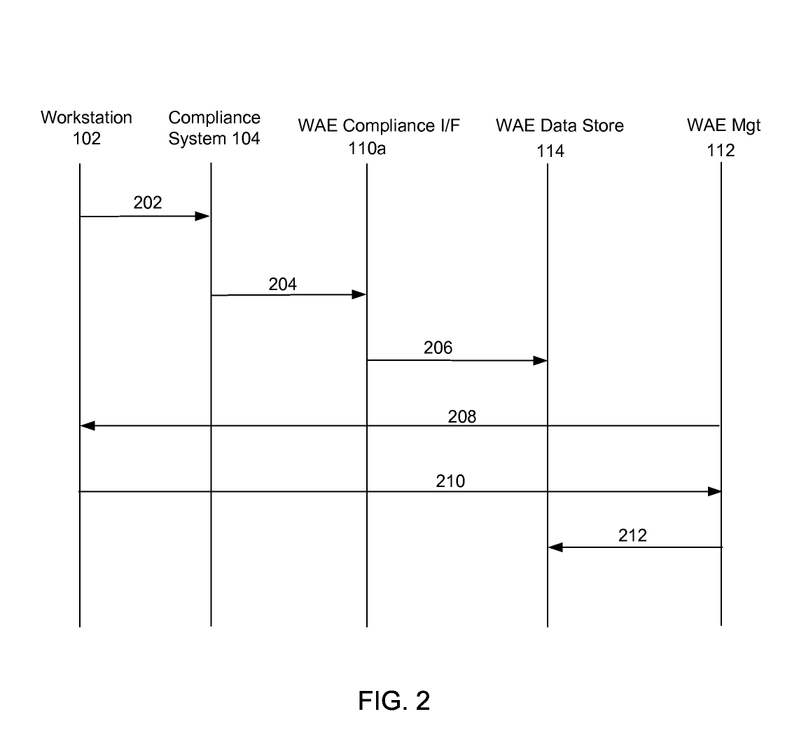

Referring now to FIG. 2, shown is an event diagram depicting an embodiment of a process of requesting temporary administrator permission according to one embodiment. The process shown assumes that a user is running a browser 120 or other client application (FIG. 1) via its workstation 102 over network 108 (FIG. 1), to access and interact with user data and/or a network-based resource. In an exemplary scenario, the user has authenticated itself via entry of a login identifier and password to an authentication service. Next, the user logs into the compliance system 104 used to request access to entities within the network 108.

Therefore, for the process in FIG. 2, the user requests 202 temporary administrators membership on workstation(s) 102 and pertinent request details. The compliance system 104 receives the request and makes a web service (SOAP) call 204 to the workstation account elevation (temporary) compliance interface service 110a passing information related to the request. The information includes a role to be assigned to the user, the user's ID (identifier), and/or the expiration period for permission being authorized. The temporary compliance interface service 110a creates 206 an entry in the WAE data store 114 granting the user authorization to add itself to the administrators group on workstation(s) 102 and sets the expiration for the authorization. The workstation account elevation management service 112 communicates 208 with the user and instructs the user to register as an administrator on a workstation 102. In one embodiment, the management service 112 particularly sends 208 the user an email with a link to an executable (e.g., executable file residing at a network share to the WAE tool 122) needed to add itself to an administrators group on applicable workstations.

Referring back to FIG. 1, one embodiment of the workstation account elevation server 106 therefore may include a compliance interface service 110 that accepts access authorizations from a compliance system 104 and carries out the granting of or revocation of the permissions authorized by the compliance system 104. Correspondingly, one embodiment of a workstation 102 may also include a WAE tool 122 that is installed on a workstation 102 from an executable file residing on the network share that the user initiates to claim or release the user's administrator privileges and a service comprising an update tool 124, such as a local windows service, that performs on the workstation 102 to automatically remove users from a local administrators group when the user's permission expires or is revoked. The WAE tool 122 and/or update tool 124 also provide information to a local operating system (e.g., Microsoft Windows 7® operating system) and/or components of the workstation account elevation server 106.

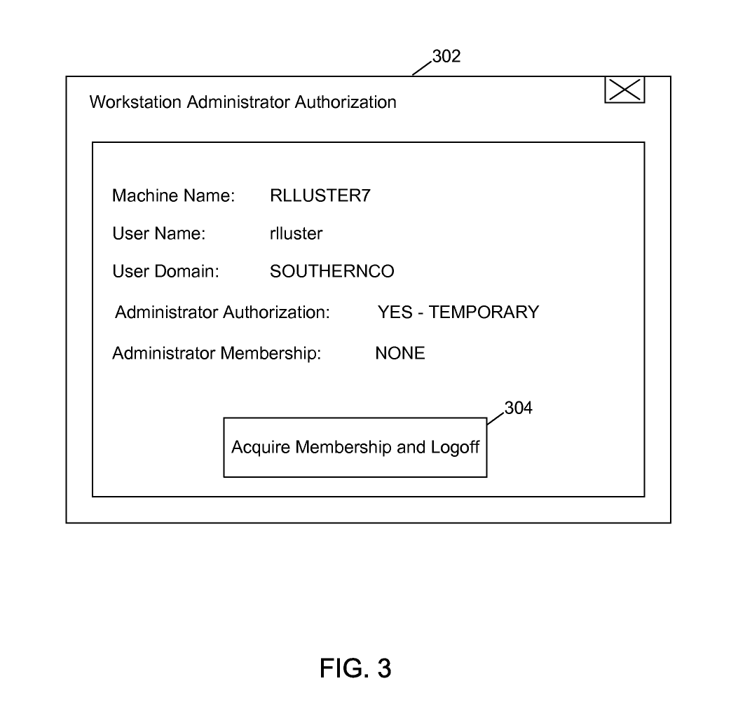

Therefore, when a workstation 102 launches the executable file linked in the email, the workstation 102 makes a web service call to the workstation account elevation server 106 to determine what authorizations the user has been granted and what permissions are currently associated with the user on the workstation 102. In one embodiment, the WAE tool 122 is installed on the workstation 102 also as a result of executing the file linked to the email. Execution of the WAE tool 122 encodes for display a user interface 302 with a button 304 or other input component, as shown in FIG. 3 (and discussed below in additional detail). For example, the user interface 302 may include various components including text input fields, drop-down boxes, sliders, checkboxes, radio buttons, and/or other user interface components in other embodiments.

In one embodiment, if the user has authorization to claim to be an administrator in the administrators group on the workstation 102 from which the WAE tool 122 is executed, the WAE tool 122 adaptively labels the button on the displayed user interface with a description stating to “Acquire Administrators Permissions and Log Off.” Therefore, when the user selects or clicks the button, it will cause the user to be added to the administrators group and be recorded in a local administrators list 126 in a registry of active administrators for the workstation 102 (and also record the scheduled expiration of the permission and/or date the permission was added on the list 126). Additionally, the workstation 102 is caused to make a web service call 210 (FIG. 2) to the workstation account elevation server 106 to record 212 (FIG. 2) that the user has been added to the administrators group on its version of the administrators list 116 (and also record the scheduled expiration of the permission and/or date the permission was added).

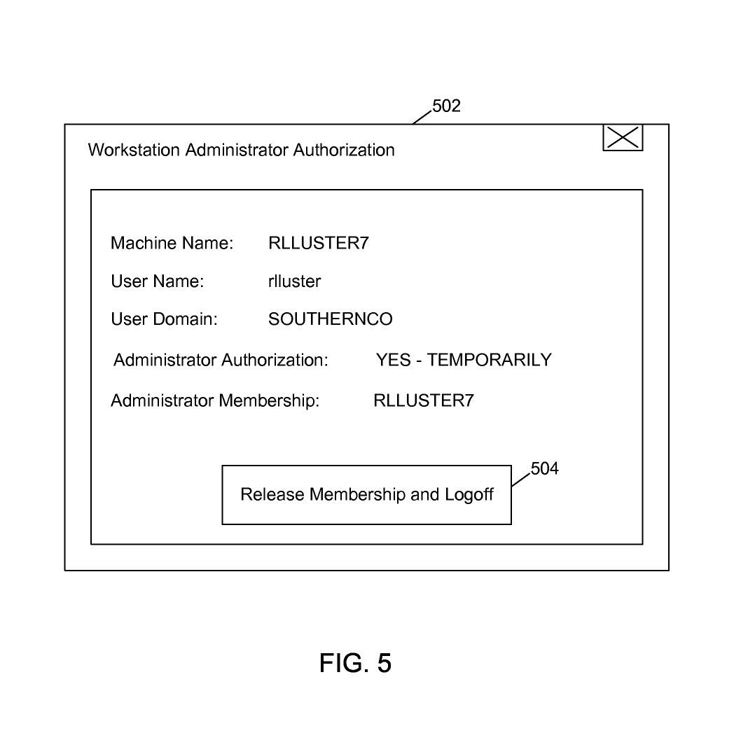

Further, to terminate or release administrator permissions associated with a user for a particular workstation, the WAE tool 122 may be executed to display the user interface with a button labeled with “Release Administrators Permissions and Log Off” (as shown in FIG. 5 and discussed below in additional detail). Selection of the button causes the user to be removed from the administrators group and to be removed from the local administrators list 126 in the registry of active administrators for the workstation 102 (and also record the date the permission was removed). If the WAE tool 122 is not used to release the user's administrator permissions, the permissions will eventually expire.

Additionally, the update tool 124 running on the workstation 106 periodically or regularly checks for any active administrators whose permissions have expired. For an expired permission, the update tool 124 removes the user from the local administrators group, makes a web service call to update the WAE data store 114 that the user has been removed, records the time of the removal, and/or then forcibly causes the user to log off the workstation 102. Accordingly, when the user logs back in, administrator permissions are cleared off a token of the user and the user no longer has administrator permissions for the workstation 102.

To track requests and grants of administrator permissions, embodiments of the workstation account elevation server 106 and workstation 102 keep separate administrators lists 116, 126 of the user IDs that have been granted permissions on the workstation 102 and when the relevant permissions expire. In one embodiment, an administrators list 126 on the workstation 102 is embedded with an encrypted hash to detect tampering, while remaining human readable for troubleshooting purposes. Therefore, if changes are made to the administrators list 126 and that hash is not updated, then the list 126 can be determined to be invalid. As a result, the workstation 102 can retrieve a copy of the administrators list 116 at the workstation account elevation server 106 to be stored locally on the applicable workstation 102.

In some embodiments, the compliance system 104 can be used to revoke permissions for a user to a workstation 102. In such a case, the administrators list 116 at the workstation account elevation server 106 can be updated and then copied or updated to the workstation 102 at a later time, such as when the update tool 124 periodically syncs with the workstation account elevation server 106 in some embodiments.

Referring now to FIG. 3, after the user is authorized by the compliance system 104, the WAE tool 122 presents a user interface with an option to register as an administrator on a current workstation 102. An exemplary user interface screen 302 is shown in FIG. 3.

Here, the user may click or select 302 the “Acquire Membership and Logoff” button 304 at which point the user is added to the local administrators group on the workstation 102 and logged off of the workstation 102. When the user logs back into the workstation 102, the user is provided full administrator privileges associated with the local administrators group. During this exemplary process in one embodiment, the WAE tool 122 performs actions of calling 304 the workstation account elevation web service to log the workstation 102 where the permissions were claimed; adding a record 306 to the local administrators list 126 to record that the expiration date and time of the authorization; and/or adding the user as a member to the local administrators group.

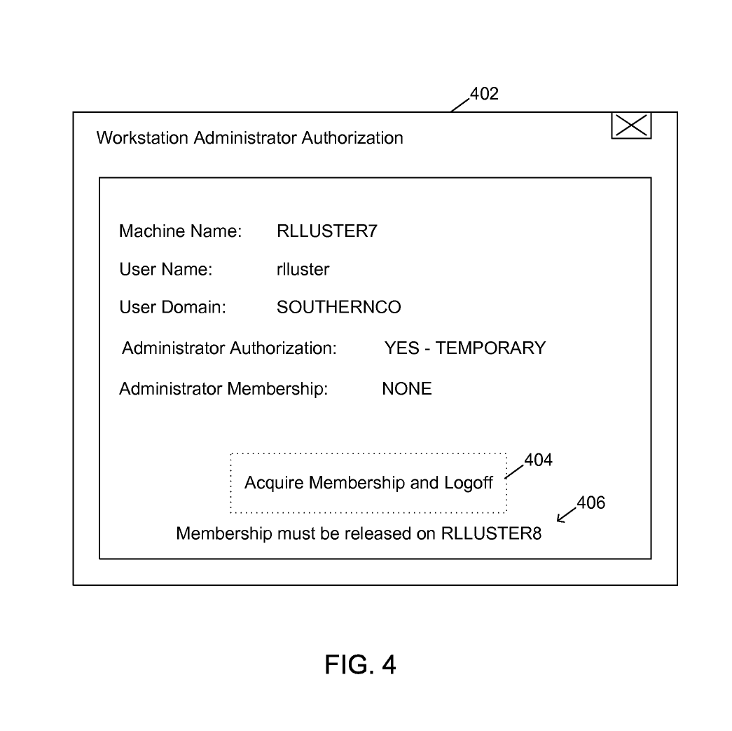

In one embodiment, temporary authorization only allows the user to be a member of an administrators group on any workstation as long as the user does not have a number of active permissions exceeding a predefined number (and a term of the temporary permission has not expired). For example, in some embodiments, a user is allowed to be an administrator on a single workstation at a time. Therefore, if the user attempts to use the authorization to obtain administrator permissions on another workstation, the user will be presented a user interface 402 (FIG. 4) informing the user that the user needs to release administrator permissions that have been claimed for a previous workstation, as represented by the dialog text 406 of the user interface 402 depicted in FIG. 4. The user may then go back to the other workstation 102a, execute the WAE tool 122, and click the “Release Membership and Logoff” button 504 from the user interface 502 provided (as shown in FIG. 5), before acquiring administrator permissions on a different workstation 102b.

Accordingly, in such an exemplary embodiment, a user is allowed to have temporary administrative rights for a single workstation at a time. To do so, a user may log in to one workstation 102a and claim its temporary rights. To acquire temporary administrative rights on a different workstation, then the user will need to release its rights; log in to a second workstation 102b; and claim its rights on the second workstation 102b. Alternatively, in other embodiments, a user is allowed to have temporary administrative rights for a predefined number of workstations at a time that can be greater than one (e.g., 3 workstations at a time).

As has been previously addressed, an update tool 124, such as a local windows service, has been implemented on each workstation 106 to monitor for expiring authorizations on that workstation 102. When a user's authorization to be a member of the administrators group expires, the update tool 124 performs the following: removes the user with an expiring authorization from the local administrators group on the workstation 102; updates the local authorization list (administrators list 116) to reflect that the user has been removed; calls the workstation account elevation management service 112 to update the WAE data store 114 with data indicating that the expiration has been processed; and/or searches, by the update tool 124, all active sessions (e.g., windows sessions) on the workstation 102 for a session belonging to the user with an expired authorization. If such an active session is found, a user interface dialog box is encoded for displayed the WAE tool 122 in that session warning the user that the administrator permission of the user is expired. If the user closes the dialog box or clicks a button indicating acknowledgment (e.g., an OK button), the user is immediately logged off the workstation 102. If the user does not respond to the dialog or interface option, then the user is to be automatically logged off of its session after a set period of time, e.g. 5 minutes. This acts to clear the administrator privileges from the user token on the workstation 102.

In addition to temporary administrator permissions, long-term administrator permissions can also be authorized on workstations 102, in some embodiments. For example, such an exemplary process works in the same way as the temporary authorizations but provides a process for recertifying the permissions yearly and removing the permissions automatically if the user's job changes. Since the term of a long-term administrator permission (e.g., 1-year term) is longer than a temporary administrator permission (e.g., term is less than 1-year), additional strings may be attached to long-term permissions as compared to temporary permissions.

For example, in some embodiments, long-term administrators group membership can only be requested for specific workstations 102 or is dependent on workstations identified in the request. Therefore, unlike an exemplary temporary membership which may be used on any workstation 102, an exemplary long-term membership may be locked to the workstations 102 identified in (or associated with) the approved request for long-term administrator permission.

In an illustrative process scenario, a user logs into the compliance system 104, requests long-term administrators membership on selected workstations 102, and completes the necessary request details including a list of workstations 102 for which the user is requesting the administrator privileges or permissions. The compliance system 104 then makes a web service (SOAP) call to the workstation account elevation (long-term) compliance interface service 110b passing information related to the request. The information includes the role, the user's ID, and the list of workstations 102 where the permissions are requested.

Before responding to the user, the workstation account elevation management service 112 creates an entry in the WAE data store 114 granting the user authorization to add itself to the administrators group on the specific workstations 106 and sets the expiration for the authorization. Afterwards, the workstation account elevation management service 112 communicates 208 with the user and instructs the user to register as an administrator on a workstation 102.

In one embodiment, the management service 112 particularly sends 208 the user an email with a link to an executable (e.g., executable file residing at a network share to the WAE tool 122) needed to add itself to an administrators group of the current workstation 102. It is noted that with long-term permissions, a user can have administrator permissions concurrently on all of the workstations in the list that was approved, in accordance with an exemplary embodiment.

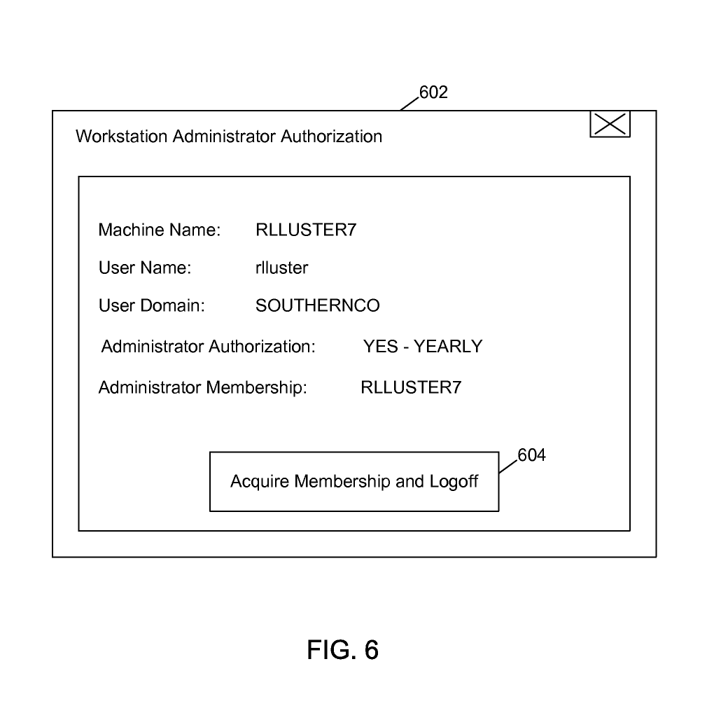

Then, when the user clicks on the link in the email that the user receives from the workstation account elevation management service 112, the user is presented with a user interface screen by the WAE tool 122. An exemplary user interface screen 602 is depicted in FIG. 6.

Here, the user may click an “Acquire Membership and Logoff” button 604 at which point the user will be added to the local administrators group on the current workstation 102 and logged off of the workstation 102. After which, when the user logs back into the workstation 102, the user will have full administrator privileges.

During this exemplary process, the WAE tool 122 performs updates to the local administrators list 126 to record the expiration date and time of the authorization. This acts to avoid excessive calls to the web services at the workstation account elevation server 106 to access the administrators list 116 maintained by the server 106. In some embodiments, the administrators list is tamper proofed with an encrypted hash. Various embodiments of the WAE tool 122 also perform adding the user to the local administrators group. The long-term authorization allows the user to release its membership privileges and reacquire them whenever the user wants, but membership privileges can only be acquired on workstations 102 that are listed in the authorization grant from the compliance system 104.

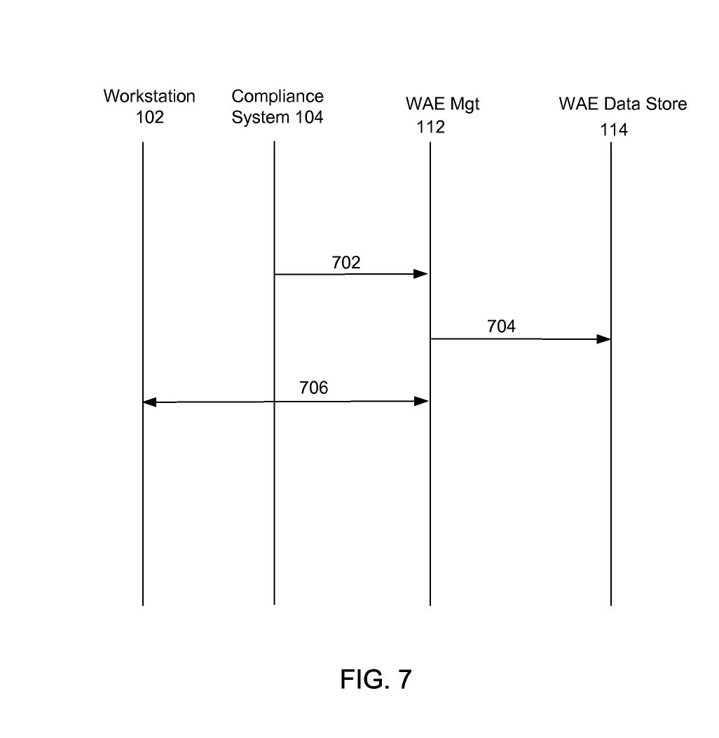

Next, an event diagram of an exemplary process is depicted in FIG. 7. The diagram represents an operational flow for the instance where administrators group membership privileges are revoked. In an exemplary scenario, authorizations for membership in local administrators groups can be revoked or released at any point through the compliance system 104. Accordingly, when an administrator permission is revoked for a user, the compliance system 104 calls 702 a workstation account elevation management service 112. The management service 112 updates 704 the administrator authorization or permission in the WAE data store 114 to set the expiration on the authorization to be immediate.

In one embodiment, the update tool 124 on workstation 102, such as a local windows service running on the workstation 102, polls 706 the workstation account elevation management service 112 of the workstation account elevation server 106 periodically for updates to authorizations that are in use on the respective local workstation. Therefore, if an authorization has been updated, the workstation 102 via the update tool 124 updates the local administrators list 126 with the new expiration. Once the new expiration is acquired by the update tool 124, the revocation is processed in a similar manner as an expiring authorization on the local workstation 102.

One benefit of this solution, among others, is that it allows the user to add and remove itself from the local administrators group on a workstation 102, so long as the user has the authorization to do so. For example, this allows a user, such as a software developer, with administrator privileges to relinquish those privileges to test software (under development) on a workstation 102 as a normal user and then reacquire the administrator privileges on the workstation 102, whenever the user needs them. Correspondingly, whenever a user acquires or releases its privileges or permissions, a record of the transaction is saved in the WAE data store 114 for auditing purposes.

Additionally, embodiments of the present disclosure may utilize process(es) that execute on one or more servers in a central location. In one embodiment, the duties of the WAE tool 122 and update tool 124 may be performed by processes 123, 125 residing at a central server 109, and therefore, no installed components associated with the workstation account elevation server 106 are required on the workstations 102 themselves, in such embodiments.

In an exemplary optional centralized process implementation, a centralized update process 125 (performing duties of the update tool 124) polls the management service 112 of the workstation account elevation server 106 at specified intervals for expirations that need to be processed. Since revocations are implemented by setting the expiration to immediate, the centralized update service 125 will process the expirations on a next cycle of the update service 125 and follow a similar process as is used for a regular authorization expiration. Correspondingly, in an exemplary optional centralized process implementation, a centralized WAE process 123 (performing duties of the WAE tool 122) adds users to administrators groups of workstations 102, as instructed by the compliance system 104.

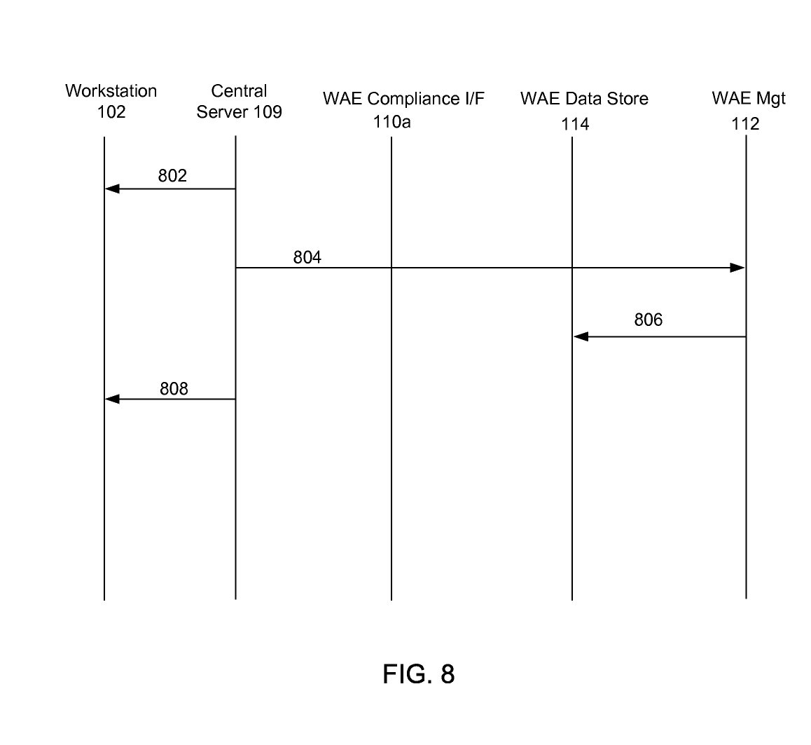

Next, an event diagram of an exemplary process is depicted in FIG. 8. The diagram represents an operational flow in the instance where administrators group membership privileges are expired under the centralized update process 125. According to various embodiments, the centralized update process 125 optionally can be used in place of or in tandem with the local update tool 124. Generally, the centralized update process 125 duplicates functions of the local update tool 124 but resides at the central server 109 (as opposed to a workstation 102).

In FIG. 8, under one exemplary scenario, when a user's authorization to be a member of the administrators group on a workstation 102 expires, the centralized update process 125 involves the following actions. The user with an expiring authorization is requested 802 to be immediately removed from the local administrators group on the workstation 102 by the update process 125. Accordingly, the central server 109 may send management commands over the network 108 to be used in managing workstations 102. The local administrators list 126 on the workstation 102 is updated to reflect that the user has been removed from the administrators group on the workstation 102.

The workstation account elevation management service 112 is also called 804 to update 806 the WAE data store 114 with data indicating that the expiration has been processed. The update process or service 125 searches 808 all active sessions (e.g., windows sessions) on the workstation 102 for a session belonging to the user with an expired authorization. If such a session is found, a dialog box is provided by the WAE process 123 and displayed in that session warning the user that the user's authorization is expired. If the user closes the dialog box (e.g., clicks an OK button within the dialog interface), the user is immediately logged off at request of the WAE process 123. If the user does not respond to the dialog, then the user is automatically logged off of the user's session after a set period of time, e.g., 5 minutes, at request of the WAE process 123. This acts to clear the administrator privileges from the user token.

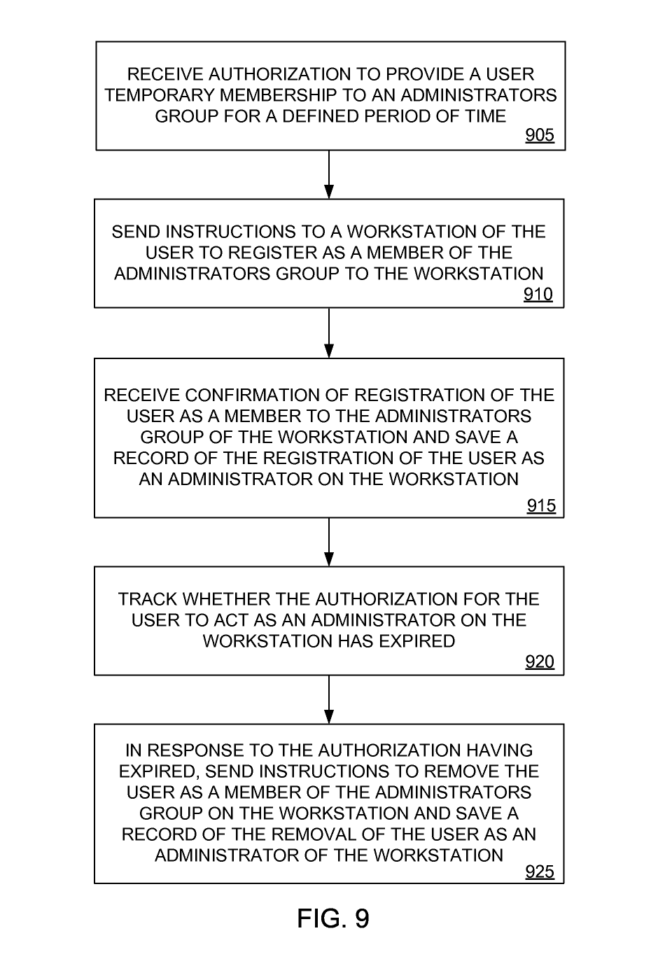

Referring next to FIG. 9, shown is a flowchart that provides one example of the operation of a portion of the account elevation environment 100 according to various embodiments. It is understood that the flowchart of FIG. 9 (and subsequent flowcharts) provide merely an example of the many different types of functional arrangements that may be employed to implement the operation of the portion of the account elevation environment 100 as described herein. As an alternative, the flowchart of FIG. 9 (and subsequent flowcharts) may be viewed as depicting an example of steps of a method implemented by device(s) of the account elevation environment 100 according to one or more embodiments.

In box 905, a network server (e.g., workstation account elevation server 106) receives authorization to provide a user temporary membership to an administrators group for a defined period of time. In some embodiments, the temporary membership is limited to being actively applied to a predefined number or amount of workstations only. As a result, the network server sends instructions to a workstation of the user to register as a member of the administrators group to the workstation, in box 910. From the workstation, the network server receives confirmation of registration of the user as a member to the administrators group of the workstation 102 and saves a record of the registration of the user as an administrator on the workstation, in box 915. The network server also tracks whether the authorization for the user to act as an administrator on the workstation has expired, in box 920; and in response to the authorization having expired, sends instructions to remove the user as a member of the administrators group on the workstation and saving a record of the removal of the user as an administrator of the workstation, in box 925.

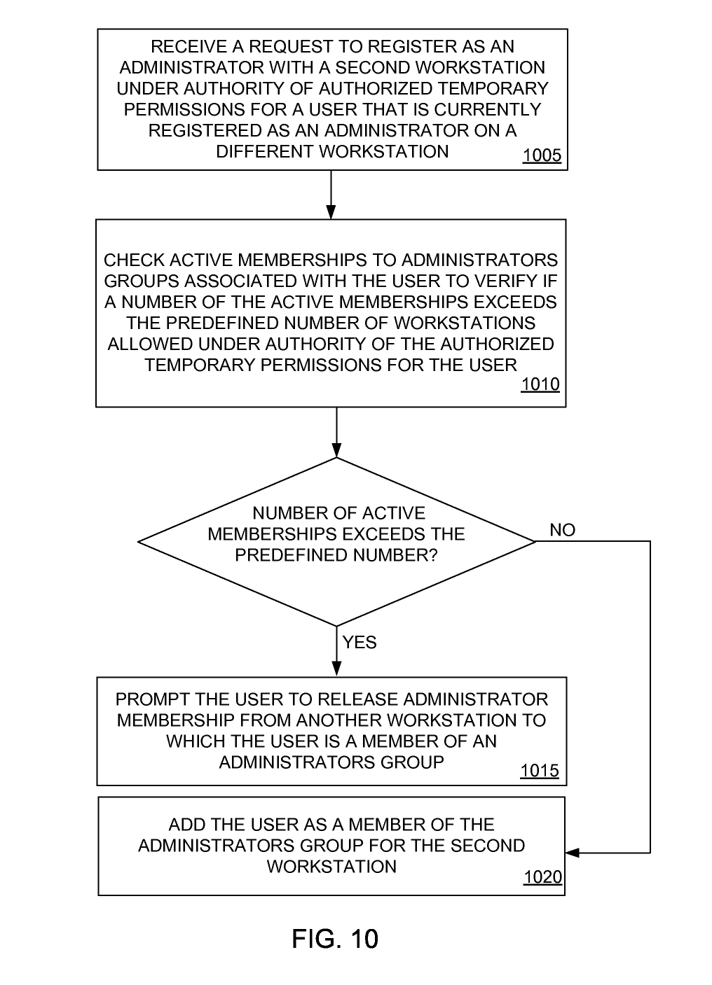

Referring next to FIG. 10, shown is a flowchart that provides another example of the operation of a portion of the account elevation environment 100 according to various embodiments. In box 1005, a network server (e.g., workstation account elevation server 106) receives a request to register as an administrator with a second workstation under authority of authorized temporary permissions for a user that is currently registered as an administrator on a different workstation. As a result, the network server 106 checks active memberships to administrators groups associated with the user to verify if a number of the active memberships exceeds the predefined number of workstations allowed under authority of the authorized temporary permissions for the user, in box 1010. If the number of active memberships exceeds the predefined number, the network server 106 causes a prompt to be presented prompting the user to release administrator membership from another workstation to which the user is a member of an administrators group, in box 1015. Alternatively, if the number of active memberships is less than the predefined number, the network server 106 causes the user to be added as a member of the administrators group for the second workstation, in box 1020.

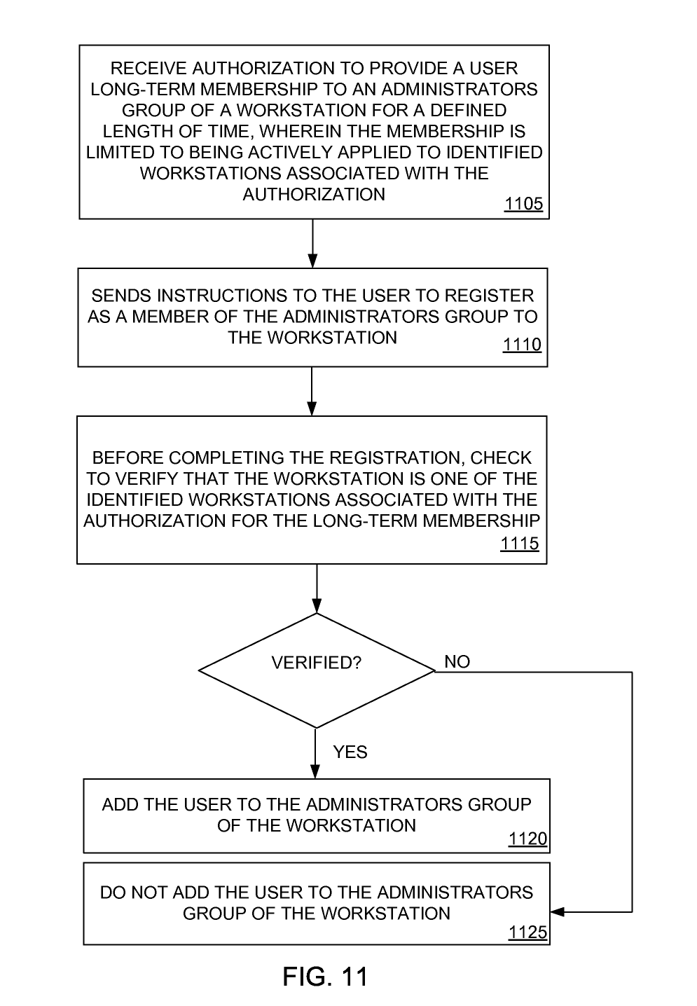

Next, FIG. 11 shows a flowchart that provides an additional example of the operation of a portion of the account elevation environment 100 according to various embodiments. In box 1105, a network server (e.g., workstation account elevation server 106) receives authorization to provide a user long-term membership to an administrators group of a workstation for a defined length of time, wherein the long-term membership is limited to being actively applied to a list of identified workstations associated with the authorization. As a result, the network server 106 sends instructions to the user to register as a member of the administrators group to the workstation, in box 1110. Then, before completing the registration, a check is performed to verify that the workstation is one of the identified workstations associated with the authorization for the long-term membership, in box 1115. If the workstation is verified to be one of the identified workstations, the user is added to the administrators group of the workstation, in box 1120. Otherwise, the user is not added to the administrators group of the workstation, in box 1125.

The foregoing embodiments facilitate elevation of a user account by granting of administrator permissions to workstations of network users in a manner that is manageable and auditable. Accordingly, embodiments allow for a user to elevate an administrator permission of a user's account and then de-elevate the permission when the term of the permissions expires, which may be performed on an as-needed basis.

With reference to FIG. 12, shown is a schematic block diagram of a computing device of the account elevation environment 100 according to an embodiment of the present disclosure. The computing device of the account elevation environment 100 includes at least one processor circuit, for example, having a processor 1203 and a memory 1206, both of which are coupled to a local interface 1209. To this end, the account elevation environment 100 may comprise, for example, at least one server computer or like device. The local interface 1209 may comprise, for example, a data bus with an accompanying address/control bus or other bus structure as can be appreciated.

Stored in the memory 1206 are both data and several components that are executable by the processor 1203. In particular, stored in the memory 1206 and executable by the processor 1203 are the workstation account elevation compliance interface service(s) 110, workstation account elevation management service 112, and potentially other applications or services. Also stored in the memory 1206 may be data store(s) 114 and other data. In addition, an operating system 1213 may be stored in the memory 1206 and executable by the processor 1203 and network interface application(s) may be used to communicate using network protocols.

It is understood that there may be other applications that are stored in the memory 1206 and are executable by the processors 1203 as can be appreciated. Where any component discussed herein is implemented in the form of software, any one of a number of programming languages may be employed such as, for example, C, C++, C#, Objective C, Java, Java Script, Perl, PHP, Visual Basic, Python, Ruby, Delphi, Flash, or other programming languages.

A number of software components are stored in the memory 1206 and are executable by the processor 1203. In this respect, the term “executable” means a program file that is in a form that can ultimately be run by the processor 1203. Examples of executable programs may be, for example, a compiled program that can be translated into machine code in a format that can be loaded into a random access portion of the memory 1206 and run by the processor 1203, source code that may be expressed in proper format such as object code that is capable of being loaded into a random access portion of the memory 1206 and executed by the processor 1203, or source code that may be interpreted by another executable program to generate instructions in a random access portion of the memory 1206 to be executed by the processor 1203, etc. An executable program may be stored in any portion or component of the memory 1206 including, for example, random access memory (RAM), read-only memory (ROM), hard drive, solid-state drive, USB (Universal Serial Bus) flash drive, memory card, optical disc such as compact disc (CD) or digital versatile disc (DVD), floppy disk, magnetic tape, or other memory components.

The memory 1206 is defined herein as including both volatile and nonvolatile memory and data storage components. Volatile components are those that do not retain data values upon loss of power. Nonvolatile components are those that retain data upon a loss of power. Thus, the memory 1206 may comprise, for example, random access memory (RAM), read-only memory (ROM), hard disk drives, solid-state drives, USB flash drives, memory cards accessed via a memory card reader, floppy disks accessed via an associated floppy disk drive, optical discs accessed via an optical disc drive, magnetic tapes accessed via an appropriate tape drive, and/or other memory components, or a combination of any two or more of these memory components. In addition, the RAM may comprise, for example, static random access memory (SRAM), dynamic random access memory (DRAM), or magnetic random access memory (MRAM) and other such devices. The ROM may comprise, for example, a programmable read-only memory (PROM), an erasable programmable read-only memory (EPROM), an electrically erasable programmable read-only memory (EEPROM), or other like memory device.

Also, the processor 1203 may represent multiple processors 1203 and the memory 1206 may represent multiple memories 1206 that operate in parallel processing circuits, respectively. In such a case, the local interface 1209 may be an appropriate network 108 (FIG. 1) that facilitates communication between any two of the multiple processors 1203, between any processor 1203 and any of the memories 1206, or between any two of the memories 1206, etc. The local interface 1209 may comprise additional systems designed to coordinate this communication, including, for example, performing load balancing. The processor 1203 may be of electrical or of some other available construction.

Although the network-based resource and other various systems described herein may be embodied in software or code executed by general purpose hardware as discussed above, as an alternative the same may also be embodied in dedicated hardware or a combination of software/general purpose hardware and dedicated hardware. If embodied in dedicated hardware, each can be implemented as a circuit or state machine that employs any one of or a combination of a number of technologies. These technologies may include, but are not limited to, discrete logic circuits having logic gates for implementing various logic functions upon an application of one or more data signals, application specific integrated circuits having appropriate logic gates, or other components, etc. Such technologies are generally well known by those skilled in the art and, consequently, are not described in detail herein.

The flowcharts of FIGS. 9-11 show the functionality and operation of an implementation of portions of the account elevation environment 100. If embodied in software, each block may represent a module, segment, or portion of code that comprises program instructions to implement the specified logical function(s). The program instructions may be embodied in the form of source code that comprises human-readable statements written in a programming language or machine code that comprises numerical instructions recognizable by a suitable execution system such as a processor 1203 in a computer system or other system. The machine code may be converted from the source code, etc. If embodied in hardware, each block may represent a circuit or a number of interconnected circuits to implement the specified logical function(s).

Although the FIGS. 9-11 show a specific order of execution, it is understood that the order of execution may differ from that which is depicted. For example, the order of execution of two or more blocks may be scrambled relative to the order shown. Also, two or more boxes shown in succession in FIGS. 9-11 show may be executed concurrently or with partial concurrence. In addition, any number of counters, state variables, warning semaphores, or messages might be added to the logical flow described herein, for purposes of enhanced utility, accounting, performance measurement, or providing troubleshooting aids, etc. It is understood that all such variations are within the scope of the present disclosure.

Also, any logic or application described herein, including the network-based resource, that comprises software or code can be embodied in any computer-readable medium for use by or in connection with an instruction execution system such as, for example, a processor 1203 in a computer system or other system. In this sense, the logic may comprise, for example, statements including instructions and declarations that can be fetched from the computer-readable medium and executed by the instruction execution system. In the context of the present disclosure, a “computer-readable medium” can be any medium that can contain, store, or maintain the logic or application described herein for use by or in connection with the instruction execution system. The computer-readable medium can comprise any one of many physical media such as, for example, electronic, magnetic, optical, electromagnetic, infrared, or semiconductor media. More specific examples of a suitable computer-readable medium would include, but are not limited to, magnetic tapes, magnetic floppy diskettes, magnetic hard drives, memory cards, solid-state drives, USB flash drives, or optical discs. Also, the computer-readable medium may be a random access memory (RAM) including, for example, static random access memory (SRAM) and dynamic random access memory (DRAM), or magnetic random access memory (MRAM). In addition, the computer-readable medium may be a read-only memory (ROM), a programmable read-only memory (PROM), an erasable programmable read-only memory (EPROM), an electrically erasable programmable read-only memory (EEPROM), or other type of memory device.

Therefore, the following is claimed:

1. A system, comprising:
at least one processor; and
a compliance interface module configured to:
receive authorization to provide a user temporary membership to an administrators group for a defined period of time, wherein the temporary membership is limited to being actively applied to a predefined number of workstations; and
send instructions to a workstation of the user to register as a member of the administrators group of the workstation; and
a management module configured to:
receive confirmation of registration of the user as a member of the administrators group of the workstation and save a record of the registration of the user as an administrator on the workstation;
track whether the authorization for the user to act as an administrator on the workstation has expired; and
in response to the authorization having expired, send instructions to remove the user as a member of the administrators group on the workstation and save a record of the removal of the user as an administrator of the workstation.

2. The system of claim 1, wherein the compliance interface module is further configured to receive a request to register as an administrator with a different workstation under authority of the temporary membership and check active memberships to administrators groups associated with the user to verify if a number of the active memberships exceeds the predefined number of workstations allowed under authority of the temporary membership.

3. The system of claim 2, wherein if the number of active memberships exceeds the predefined number, a prompt is presented prompting the user to release administrator membership from another workstation to which the user is a member of an administrators group.

4. The system of claim 2, wherein if the number of active memberships is less than the predefined number, the user is added as a member of the administrators group for the different workstation.

5. The system of claim 1, wherein the predefined number is greater than 1.

6. The system of claim 1, wherein the compliance interface module is further configured to receives authorization to provide a second user long-term membership to administrators groups of one or more workstations for a defined length of time, wherein the long-term membership is limited to being actively applied to a list of identified workstations associated with the authorization, wherein the length of time associated with the long-term membership is greater than the defined period of time associated with the temporary membership, wherein the compliance interface module is further configured to send instructions to the workstation to register the second user as a member of the administrators group of the workstation.

7. The system of claim 6, wherein the compliance interface module is further configured to receive a request from the second user to register as an administrator with a different workstation under authority of the long-term membership and to verify that the different workstation is one of the identified workstations associated with the authorization for the long-term membership, wherein the compliance interface module adds the second user to an administrators group of the different workstation if the different workstation is verified to be one of the identified workstations.

8. A method comprising:
receiving, by a network server, authorization to provide a user temporary membership to an administrators group for a defined period of time, wherein the temporary membership is limited to being actively applied to a predefined number of workstations;
sending, by the network server, instructions to a workstation of the user to register as a member of the administrators group of the workstation;
receiving confirmation of registration of the user as a member of the administrators group of the workstation and saving a record of the registration of the user as an administrator on the workstation;
tracking whether the authorization for the user to act as an administrator on the workstation has expired; and
in response to the authorization having expired, sending, by the network server, instructions to remove the user as a member of the administrators group on the workstation and saving a record of the removal of the user as an administrator of the workstation.

9. The method of claim 8, wherein the instructions to the user to register as a member of the administrators group to the workstation comprises an email message sent to the user.

10. The method of claim 8, further comprising:
receiving a request to register as an administrator with a different workstation under authority of the temporary membership and checking active memberships to administrators groups associated with the user to verify if a number of the active memberships exceeds the predefined number of workstations allowed under authority of the temporary membership.

11. The method of claim 10, wherein if the number of active memberships exceeds the predefined number, a prompt is presented prompting the user to release administrator membership from another workstation to which the user is a member of an administrators group.

12. The method of claim 10, wherein if the number of active memberships is less than the predefined number, the user is added as a member of the administrators group for the different workstation.

13. The method of claim 8, further comprising:
receiving authorization to provide a second user long-term membership to administrators groups of one or more workstations for a defined length of time, wherein the long-term membership is limited to being actively applied to a list of identified workstations associated with the authorization, wherein the length of time associated with the long-term membership is greater than the defined period of time associated with the temporary membership; and
sending instructions to the workstation of the second user to register as a member to the administrators group of the workstation.

14. The method of claim 13, further comprising:
receiving a request from the second user to register as an administrator with a different workstation under authority of the long-term membership and checking to verify that the different workstation is one of the identified workstations associated with the authorization for the long-term membership; and
adding the second user to an administrators group of the different workstation if the different workstation is verified to be one of the identified workstations.

15. A non-transitory computer-readable medium embodying a program executable in a computing device, the program comprising:
code that receives authorization to provide a user temporary membership to an administrators group for a defined period of time, wherein the temporary membership is limited to being actively applied to a predefined number of workstations;
code that sends instructions to a workstation of the user to register as a member of the administrators group of the workstation;
code that receives confirmation of registration of the user as a member of the administrators group of the workstation and saves a record of the registration of the user as an administrator on the workstation;
code that tracks whether the authorization for the user to act as an administrator on the workstation has expired; and
code that, in response to the authorization having expired, sends instructions to remove the user as a member of the administrators group on the workstation and saves a record of the removal of the user as an administrator of the workstation.

16. The non-transitory computer-readable medium of claim 15, further comprising code than receives a request to register as an administrator with a different workstation under authority of the temporary membership and checks active memberships to administrators groups associated with the user to verify if a number of the active memberships exceeds the predefined number of workstations allowed under authority of the temporary membership.

17. The non-transitory computer-readable medium of claim 16, wherein if the number of active memberships exceeds the predefined number, a prompt is presented prompting the user to release administrator membership from another workstation to which the user is a member of an administrators group,
wherein if the number of active memberships is less than the predefined number, the user is added as a member of the administrators group for the different workstation.

18. The non-transitory computer-readable medium of claim 15, wherein the predefined number is greater than 1.

19. The non-transitory computer-readable medium of claim 15, further comprising:
code that receives authorization to provide a second user long-term membership to administrators groups of one or more workstations for a defined length of time, wherein the long-term membership is limited to being actively applied to a list of identified workstations associated with the authorization, wherein the length of time associated with the long-term membership is greater than the defined period of time associated with the temporary membership; and
code that sends instructions to the workstation of the second user to register as a member to the administrators group on the workstation.

20. The non-transitory computer-readable medium of claim 19, further comprising:
code that receives a request from the second user to register as an administrator with a different workstation under authority of the long-term membership and checks to verify that the different workstation is one of the identified workstations associated with the authorization for the long-term membership; and
code that adds the second user to an administrators group of the different workstation if the different workstation is verified to be one of the identified workstations.
